(19) United States
(12) Patent Application Publication
(10) Pub. No.: US 2025/0358758 A1
(43) Pub. Date: Nov. 20, 2025

(54) METHOD FOR REFERENCE CLOCK TIME SYNCHRONIZATION IN A WIRELESS NETWORK

(71) Applicant: Robert Bosch GmbH, Stuttgart (DE)

(72) Inventors: Niklas Hessler, Bjärred (SE); Sushanta Rakshit, Santa Clara, CA (US); Daniel Jung, Lund (SE)

(21) Appl. No.: 19/006,428

(22) Filed: Dec. 31, 2024

(30) Foreign Application Priority Data
May 17, 2024 (DE) 10 2024 204 634.5

(51) Int. Cl. H04W 56/00

(52) U.S. Cl. CPC H04W 56/0045; H04W 56/001

(57) ABSTRACT

Reference clock time synchronization in a wireless network via a connection time synchronization based on an established connection to a central device, a callback message for time synchronization from the central device at a start and/or an end of a connection interval, where the callback message includes a central device reference time, calculating connection intervals elapsed between sending the callback message by the central device and receiving the callback message by the peripheral device represented by a recorded local peripheral device reference time, determining a current time drift between the received central device reference time and the recorded local peripheral device reference time based on the calculated number of connection intervals, and adjusting the peripheral device reference time based on a time offset according to the connection time synchronization and based on the determined time drift to synchronize with the central device local reference clock.

### BACKGROUND

The invention relates to a method for reference clock time synchronization in a wireless network. Further, the invention relates to a peripheral device, a central device, a system, and a computer program for this purpose.

Bluetooth Low Energy (BLE) is a wireless communication technology that was introduced as part of the Bluetooth 4.0 standard. It was developed to enable low-power connections between devices over short distances. BLE is particularly suitable for applications that require intermittent data exchange and have strict power consumption requirements. BLE works in the same 2.4 GHz frequency band as classic Bluetooth but consumes significantly less energy. This makes it ideal for a wide range of devices, including wearable fitness trackers, smartwatches, medical devices and IoT (Internet of Things) devices. BLE has a simpler and leaner communication protocol than classic Bluetooth, resulting in faster and more reliable data transmission. It also supports the concept of low-latency connections, which means devices can establish and maintain a connection quickly, minimizing delays and ensuring a seamless user experience.

An intrinsic constraint of the BLE protocol is that a travel time of data packages is often unknown. This is a result of software implementation itself, but also due to technical constraints such as differences in timing of individual devices as a result of the crystal oscillator accuracy. BLE uses the 2.4 GHz band partitioned into 40 individual channels. In order to avoid congestions and data package delays when a lot of BLE (or Wi-Fi) devices are communicating at the same time, frequency hopping is applied, i.e., changing bands continuously. If frequency hopping is not sufficient or other effects such as too low signal strength led to a package not being sent, the BLE protocol applies a so-called retry and will then try to send the package repeatedly until it has been received successfully. Since the number of retries is unknown and due to the before mentioned constraints, the travel time is also unknown. Sending packages happens during specified transmission windows (connection intervals), where connected devices can listen for or send packages, followed by periods of no transmission. If a package transmission requires too many retries and the end of the current transmission window is reached, it may happen that transmission of said package will be halted until the next transmission window starts, adding to the uncertainty of the travel time. The current state of technology does not offer any stable, long-term time synchronization possibility based on the standard BLE protocol.

### SUMMARY

According to aspects of the invention a method, a computer program, a peripheral device, a further method, as well as a central device with the features of the disclosure are provided. Features and details described in the context to the method also correspond to the inventive computer program, the inventive data processing apparatus as well as the inventive computer-readable storage medium, and vice versa in each case.

According to an aspect of the invention a method for reference clock time synchronization in a wireless network is provided, wherein the wireless network is a Bluetooth Low Energy wireless network. The method comprises the following steps carried out by a peripheral device of the wireless network:

In a first step a connection or initial time synchronization procedure is performed based on an established connection to a central device to synchronize with the central device reference clock. This gives an initial synchronization of the peripheral device reference clock with the central device reference clock. Differences in the crystal oscillator of each device will advantageously quickly degrade this initial synchronization.

In a next step a callback message for time synchronization is received from the central device at a start and/or an end of a connection interval, wherein the callback message comprises a central device reference time, which corresponds to a local reference time of the central device at the time point of sending the call back message to the peripheral device. This has the effect, that travel times of the call back messages between the central device and the at least one peripheral device are synchronized with the connection interval (CI), which advantageously enables a calculation of the times for the time synchronization. A callback message can be a notification or response sent by a peripheral device to a central device such as a smartphone, tablet, or computer to inform it about a particular event or a status change. For example, a callback message may be utilized in case of a specific event, which may occur on the peripheral device and requires a notification to the central device. This event could be anything from a sensor reading reaching a certain threshold to a button press on a remote control device. The callback message may contain information about the event, such as its type and any relevant data.

A connection interval defines a time duration between the start of two consecutive connection events between the central device and the peripheral devices. During each connection event, data packets can be exchanged between the devices. Within each connection interval, one or more connection events occur. A connection event consists of specific phases, including the connection event itself, the data exchange, and any idle time. The number of connection events per connection interval depends on the connection parameters negotiated between the devices. Further, the choice of a connection interval can depend on specific requirements of an application. For real-time applications requiring low latency, a shorter connection interval may be preferred to ensure timely data exchange. In contrast, applications prioritizing power efficiency may opt for longer connection intervals to minimize energy consumption.

In a next step a number of connection intervals is calculated having elapsed between the sending of the callback message by the central device and the reception of the callback message by the peripheral device. Here, the time point of reception of the callback message is represented by a recorded local peripheral device reference time.

In a next step a current time drift between the received central device reference time and the recorded local peripheral device reference time is determined based on the calculated number of connection intervals.

This has the advantage that correct travel times of callback messages between the peripheral and the central device reference clock can be determined with high precision to effectively compensate the drift.

In a next step the peripheral device reference time is adjusted based on a time offset according to the connection time synchronization procedure and based on the determined time drift to synchronize with the central device local reference clock. Adjusting the peripheral device reference time preferably comprises synchronizing the peripheral device reference time with the central device local reference clock.

The time synchronization procedure according to the invention allows to ensure that timestamps on data transactions or events across the wireless network are more accurate and consistent. Furthermore, this advantageously enables a better data integrity and ensures the reliability of data operations.

In a further example, the method comprises the following step:
Recording, specifically storing, the local peripheral reference time when receiving the callback message, to enable calculating the number of connection intervals.

This allows to carry out necessary calculations regarding a possible time difference and/or a possible drift between the peripheral and central device reference time much more efficient.

In an alternative example, the method comprises the following step:
Establishing a connection to the central device of the wireless network.

This allows the peripheral device to exchange data with a central device after establishing the connection.

In an alternative example, the callback message is received periodically, wherein the time period for receiving the callback message is configured so that the maximum time drift is smaller than half a connection interval.

This has the advantage that the central device can synchronize its operations with the peripheral devices more effectively. Further, Periodic callback messages allows to maintain a consistent communication rhythm between the central and peripheral devices. This consistency improves the reliability of data exchange by reducing the likelihood of missed or delayed messages, resulting in a more robust communication link. Furthermore, Configuring the time period for receiving callback messages to minimize time drift ensures efficient power management. By aligning the callback message intervals with the connection interval, both devices can optimize their power usage, maximizing battery life without sacrificing responsiveness.

In an alternative example, during the receiving of the callback message the method comprises the further following step:
Receiving the callback message, sent by the central device in response to receiving a callback from the peripheral device, to obtain travel times of callback messages that are synchronized with the connection intervals.

Specifically, the received callback message is sent by the central device depending on a central data received callback to obtain travel times of callback messages that are synchronized with the connection intervals. Here, the callback message is sent directly or immediately or without delay in response to receiving the central data received callback.

This has the advantage that travel times of transmitted callback messages can be determined easier and faster because of the synchronizing with the connection intervals.

In an alternative example, during the performing of the connection time synchronization procedure the method comprises the further following steps:
Recording a local connection peripheral device reference time when a connection to the central device has been established,
Receiving a callback message for time synchronization from the central device, wherein the callback message comprises a connection central device reference time corresponding to a local reference time of the central device when a connection has been established to at least one peripheral device,
Calculating a time difference between the received connection central device reference time and the recorded local connection peripheral device reference time as a base time offset between the central and the peripheral device clock, to synchronize the central and peripheral device reference time.

This allows to advantageously transmit timestamps on data transactions or events across the wireless network in a more accurate way. Further, a time synchronization, in particular an initial synchronization based on an established connection between the devices simplifies the scalability of systems by providing a standardized time reference that can be easily maintained and scaled across a growing number of devices in the wireless network.

In another aspect of the invention, a computer program may be provided, in particular a computer program product, comprising instructions which, when the computer program is executed by a computer of a peripheral device according to the invention, cause the computer to carry out the method according to the invention. Thus, the computer program according to the invention can have the same advantages as have been described in detail with reference to a method according to the invention.

In another aspect of the invention, a peripheral device for a wireless network, preferably for a Bluetooth Low Energy wireless network, may be provided, wherein the peripheral device comprises means for carrying out the method according to the invention. As the peripheral device, for example, a computer can be provided which executes the computer program according to the invention. The computer may include at least one processor that can be used to execute the computer program. Also, a non-volatile data memory may be provided in which the computer program may be stored and from which the computer program may be read by the processor for being carried out. Thus, the peripheral device according to the invention can have the same advantages as have been described in detail with reference to a method according to the invention.

According to another aspect of the invention a further method for reference clock time synchronization in a wireless network carried out by a central device of the wireless network is provided. The wireless network is preferably a Bluetooth Low Energy (BLE) wireless network. The method comprises the following steps:
Establishing a connection to at least one peripheral device in the wireless network,
Sending a callback message for time synchronization to the at least one peripheral device, wherein the callback message comprises a central device reference time corresponding to a local reference time of the central device at establishing the connection to the at least one peripheral device,
Sending a further callback message for time synchronization from the central device at a start and/or an end of a connection interval depending on a reception of the callback message from the at least one peripheral device, wherein each further callback message comprises a further central device reference time, which corresponds to a local reference time of the central device at the time point of sending the further call back message to the at least one peripheral device.

Thus, the further method according to the invention can have the same advantages as have been described in detail with reference to a method according to the invention.

According to another aspect of the invention a central device being connected to at least one peripheral device in a wireless network, preferably in a Bluetooth Low Energy wireless network, is provided. The central device comprises means for carrying out the method according to the invention. Thus, the central device according to the invention can have the same advantages as have been described in detail with reference to a method according to the invention.

According to another aspect of the invention a system comprising the peripheral device and the central device being connectable or connected to the peripheral device in a wireless network, preferably in a Bluetooth Low Energy wireless network, is provided.

According to another aspect of the invention a computer-readable storage medium may be provided which comprises the computer program according to the invention and/or instructions which, when executed by a computer, cause the computer to carry out the steps of the method according to the invention. The storage medium may be formed as a data storage device such as a hard disk and/or a non-volatile memory and/or a memory card and/or a solid state drive. The storage medium may, for example, be integrated into the computer.

Furthermore, the method according to the invention may be implemented as a computer-implemented method.

### BRIEF DESCRIPTION OF THE DRAWINGS

Further advantages, features and details of the invention will be apparent from the following description, in which embodiments of the invention are described in detail with reference to the drawings. In this context, the features mentioned in the claims and in the description may each be essential to the invention individually or in any combination.

### Showing:

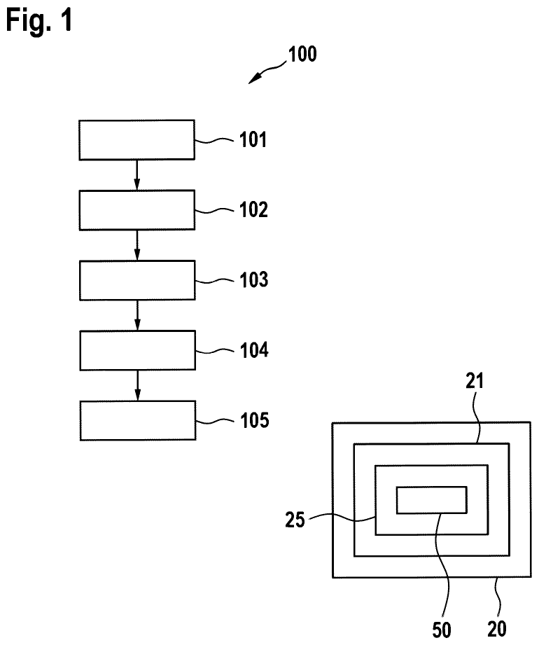

FIG. 1: A method, computer program, storage medium and a peripheral device according to embodiments of the invention,

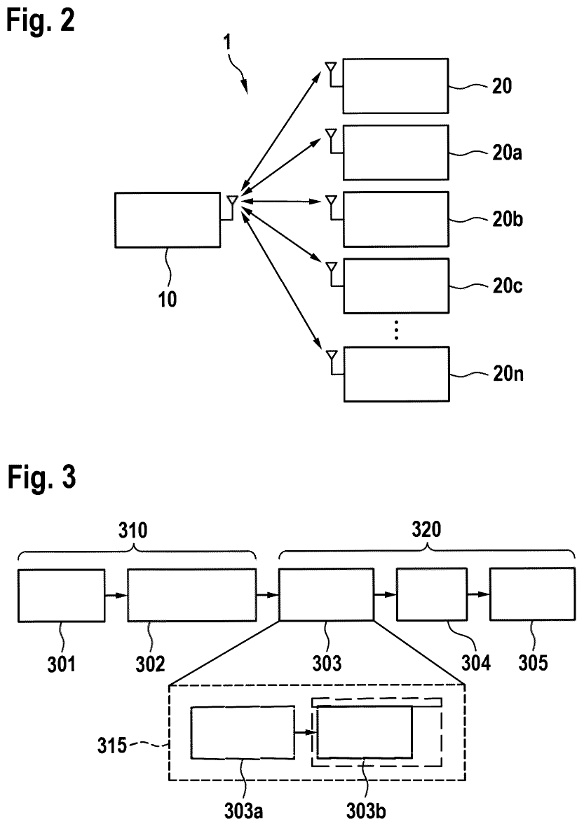

FIG. 2A schematic overview of a wireless network comprising devices according to embodiments of the invention,

FIG. 3A schematic process flow for time synchronization according to embodiments of the embodiments, and

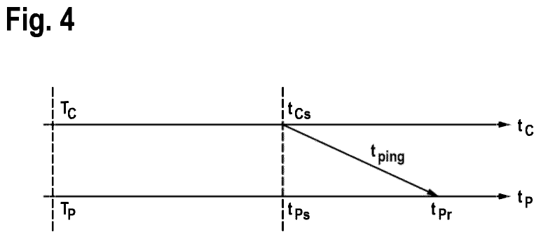

FIG. 4A schematic diagram regarding a drift of reference times TC, TP according to embodiments of the invention.

### DETAILED DESCRIPTION

The core of the invention is based on a usage of the connect callback methodology of the Bluetooth low energy standard (BLE) to create a time synchronization of a high precision of about 1 msec between a central and at least one peripheral device in a wireless BLE network. A possible drift between such devices can be adjusted by sending a callback message (connection message) and/or periodic callback messages (ping message) from a central device 10 to the at least one peripheral device 20, 20a, 20b, 20c, 20n. The drift may be a direct result of an internal clock inaccuracy of each peripheral device 20, 20a, 20b, 20c, 20n, typically expressed in ppm. Further, the method according to the invention enables to calculate the travel times, which allows to maintain an initial time synchronization. Furthermore, two distinct types of callback messages (connect and ping message) can be used for performing time synchronization. Each peripheral device 20, 20a, 20b, 20c, 20n will be time synchronized to the central device reference clock.

FIG. 1 depicts a schematic diagram of the method according to embodiments to the invention. In particular FIG. 1 shows a method 100 for reference clock time synchronization in a wireless network 1. The wireless network 1 can be a Bluetooth Low Energy BLE wireless network. The method 100 comprises the following steps carried out by a peripheral device 20, 20a, 20b, 20c, 20n in the wireless network 1:

In step 101 a connection time synchronization procedure is performed based on an established connection to a central device 10, to synchronize with the central device reference clock. In a next step 102 a callback message for time synchronization is received from the central device 10 at a start and/or an end of a connection interval, wherein the callback message comprises a central device reference time, which corresponds to a local reference time of the central device 10 at the time point of sending the call back message to the peripheral device 20, 20a, 20b, 20c, 20n.

In step 103 a number of connection intervals are calculated, which have elapsed between the sending of the callback message by the central device 10 and the reception of the callback message by the peripheral device 20, 20a, 20b, 20c, 20n, wherein a timepoint of reception of the callback message is represented by a recorded local peripheral device reference time.

In step 104 a current time drift between the received central device reference time and the recorded local peripheral device reference time is determined based on the calculated number of connection intervals. Then, in step 105 the peripheral device reference time is adjusted based on a time offset according to the connection time synchronization procedure and based on the determined time drift to synchronize with the central device local reference clock.

Further, FIG. 1 depicts a peripheral device 20 comprising a computer-readable storage medium 25. The storage medium 25 comprises a computer program 50.

FIG. 2 depicts a schematic overview of a wireless network comprising devices according to embodiments of the invention. The wireless network 1 may be a Bluetooth wireless network and in particular a Bluetooth low energy (BLE) wireless network 1. The wireless network 1 comprises a central device 10 and several peripheral devices 20, 20a, 20b, 20c, 20n. The central device 10 can be communicatively connected to one or more peripheral devices 20, 20a, 20b, 20c, 20n.

A peripheral device 20, 20a, 20b, 20c, 20n for Bluetooth Low Energy (BLE) wireless networks can be for example devices that gather data or perform specific functions and communicate that data to the central device 10, such as a smartphone or a gateway. A peripheral may be a fitness tracker such as i.e. heart rate monitors, step counters, and activity trackers that collect health and fitness data, or a Medical Device such as blood glucose monitors, blood pressure monitors, and pulse oximeters that collect and transmit health-related data, or a Smart Home Sensor for monitoring temperature, humidity, light levels, and other environmental factors in smart home systems, or a Beacons, which is a small device that broadcast signals to nearby smartphones or other devices for location-based services, such as indoor navigation or proximity marketing.

FIG. 3 shows a schematic process flow for time synchronization according to embodiments of the embodiments. In particular, a time synchronization process flow is depicted. The process can be split into an initial time synchronization procedure 310 and a continuous time synchronization procedure 315, 320 to compensate 305 a possible drift of time in a peripheral device clock.

FIG. 4 illustrates a schematic diagram regarding a drift of reference times TC, TP between a central 10 and at least one peripheral device 20, 20a, 20b, 20c, 20n. When the central device 10 and one or more peripheral devices 20, 20a, 20b, 20c, 20n connect 301 to each other a respective callback message, such as for example a connect callback or connect message, will be generated from the BLE stack on each device 10, 20, 20a, 20b, 20c, 20n. In the connect callback messages, the actual reference time Tc, TP, may be comprised and stored as a respective set value on the central device 10 and the one or more peripheral devices 20, 20a, 20b, 20c, 20n. The central device 10 sends 302 the callback message or connect message to each of the peripheral devices 20, 20a, 20b, 20c, 20n comprising its set value, which is a central reference set time Tc. When this central reference time is received by each of the peripheral devices 20, 20a, 20b, 20c, 20n, an initial time synchronization 310 of high precision, for example about 1 ms, can be performed and can be used, for example, for time stamping of transmitted device data.

All time adjustments based on the synchronization are carried out on each peripheral device 20, 20a, 20b, 20c, 20n to synchronize the peripheral reference clock time with the central device reference clock time.

They can be calculated according to the following formula:

tC=tP+(Tc−TP)=tP+ΔT

Further, time stamping in the central device 10 may be done without any time adjustments. In an ideal situation the initial time synchronization 310 could be valid and could last forever. However, in reality, the reference clocks in the peripheral devices 20, 20a, 20b, 20c, 20n and the central device 10 may drift with respect to each other. Consequently, the precision of the time synchronization quickly may become worse.

Therefore, when calculating and synchronizing the drift may be considered as follows as depicted in FIG. 3 and FIG. 4:

tC=tP+ΔT+drift.

For continuous time synchronization 315, 320, the central device 10 may send 303b a callback message or ping message to each of the connected peripheral devices 20, 20a, 20b, 20c, 20n, which should be sent periodically. The period time for this message should be configured so that the maximum clock drift is much smaller than half a connection interval (CI) 303a. This means: drift<<CI/2 (Requirement 1). The callback message for time synchronization may comprise the central reference time tCs at which the callback message or ping is sent 303b by the central device 10. The callback message or ping should be sent directly from the central data received callback from the connected peripheral device 20, 20a, 20b, 20c, 20n to obtain travel times that are synchronized with the connection interval (CI) 303a. (Requirement 2) When considering this, travel times tping for the ping or callback message will be n times the connection interval, for example, tping=n*CI msec.

As depicted in Fig, 3 and FIG. 4 after the unknown travel time tping, the peripheral device 20, 20a, 20b, 20c, 20n may receive 303b the callback message at its local peripheral time tPr. Each time a peripheral device 20, 20a, 20b, 20c, 20n receives the callback message or ping from the central device 10 comprising the central reference time tcs each peripheral device 20, 20a, 20b, 20c, 20n records or stores the reception time (tPr) of the callback message or ping. Then, the estimated peripheral time tP\tilde{s} at which the central device 10 sent the callback message is calculated 303, without drift, as:

tP\tilde{s}=TP+(tCs−TC)

To update or adjust the set values TP and TC for the time synchronization 320, the actual peripheral ping time tPs including drift is calculated 304, 305 according to the formulas below:

tPs=tP\tilde{s}+drift (4)

tPs=tPr−tPing (5)

Both, drift, and travel time tping are unknown as illustrated in FIG. 4. However, by considering the above mentioned requirements 1 and 2, the actual peripheral reference time, can be calculated as follows, since tping=n*CI

tPs=tP\tilde{s}+drift=tPr−n*CI (6)

With the requirement that the drift<<CI/2, the lower limit for n is known by

n≥(tPr−tP\tilde{s}−CI/2)*1/CI with n∈N+. (7)

Then tPs can be calculated 320, 304. Further, the (local) central reference time tCs and the (local) peripheral reference time tPs can be used as new respective set values, TP=tPs and TC=tCs. Furthermore, continued high precision time adjustments (˜1 ms) can be performed again according to the above equation (1), but with the updated set values TC and TP until the next synchronization event, where the set values will be updated or adjusted again.

The above explanation of the embodiments describes the present invention in the context of examples. Of course, individual features of the embodiments can be freely combined with each other, provided that this is technically reasonable, without leaving the scope of the present invention.

1. A method (100) for reference clock time synchronization in a wireless network (1), wherein the wireless network (1), wherein the method (100) comprises the following steps carried out by a peripheral device (20, 20a, 20b, 20c, 20n) of the wireless network (1):
performing (101) a connection time synchronization procedure based on an established connection to a central device (10) to synchronize with the central device reference clock,
receiving (102) a callback message for time synchronization from the central device (10) at a start and/or an end of a connection interval, wherein the callback message comprises a central device reference time, which corresponds to a local reference time of the central device (10) at the time point of sending the callback message to the peripheral device (20, 20a, 20b, 20c, 20n),
calculating (103) a number of connection intervals having elapsed between the sending of the callback message by the central device (10) and the reception of the callback message by the peripheral device (20, 20a, 20b, 20c, 20n) represented by a recorded local peripheral device reference time,
determining (104) a current time drift between the received central device reference time and the recorded local peripheral device reference time based on the calculated number of connection intervals, and
adjusting (105) the peripheral device reference time based on a time offset according to the connection time synchronization procedure and based on the determined time drift to synchronize with the central device local reference clock.

2. The method (100) of claim 1,
wherein, the method comprises the following step:
recording the local peripheral reference time when receiving the callback message, to enable calculating the number of connection intervals.

3. The method (100) of claim 1,
wherein, the method comprises the following step:
establishing a connection to the central device (10) of the wireless network.

4. The method (100) of claim 1,
wherein, the callback message is received periodically, wherein the time period for receiving the callback message is configured so that the maximum time drift is smaller than half a connection interval.

5. The method (100) of claim 1,
wherein during the receiving of the callback message the method comprises the further following step:
receiving the callback message, sent by the central device in response to receiving a callback from the peripheral device, to obtain travel times of callback messages that are synchronized with the connection intervals.

6. The method (100) of claim 1,
wherein during the performing of the connection time synchronization procedure the method comprises the further following steps:
recording a local connection peripheral device reference time when a connection to the central device has been established,
receiving a callback message for time synchronization from the central device, wherein the callback message comprises a connection central device reference time corresponding to a local reference time of the central device when a connection has been established to at least one peripheral device, and
calculating a time difference between the received connection central device reference time and the recorded local connection peripheral device reference time as a base time offset between the central and the peripheral device clock, to synchronize the central and peripheral device reference time.

7. A non-transitory-computer readable medium containing instructions that when executed by a computer (21) of a peripheral device (20), cause the computer (21) to carry out the method (100) of claim 1.

8. A peripheral device (20, 20a, 20b, 20c, 20n) for a wireless network, and wherein the peripheral device comprises means for carrying out the method (100) of claim 1.

9. A method (200) for reference clock time synchronization in a wireless network (1), wherein the wireless network (1) is preferably a Bluetooth Low Energy (BLE) wireless network, wherein the method (200) comprises the following steps carried out by a central device (10) of the wireless network (1):
establishing a connection to at least one peripheral device (20, 20a, 20b, 20c, 20n) in the wireless network (1),
sending a callback message for time synchronization to the at least one peripheral device (20, 20a, 20b, 20c, 20n), wherein the callback message comprises a central device reference time corresponding to a local reference time of the central device (10) at establishing the connection to the at least one peripheral device (20, 20a, 20b, 20c, 20n), and
sending a further callback message for time synchronization from the central device (10) at a start and/or an end of a connection interval depending on a reception of the callback message from the at least one peripheral device (20, 20a, 20b, 20c, 20n), wherein each further callback message comprises a further central device reference time, which corresponds to a local reference time of the central device (10) at the time point of sending the further callback message to the at least one peripheral device (20, 20a, 20b, 20c, 20n).

10. A central device (10) being connected to at least one peripheral device (20, 20a, 20b, 20c, 20n) in a wireless network (1), wherein the central device (10) comprises means for carrying out the method (200) of claim 9.
